(19) United States
(12) Patent Application Publication
(10) Pub. No.: US 2023/0301311 A1
(43) Pub. Date: Sep. 28, 2023

(54) BAKEWARE ASSEMBLY WITH TEMPERATURE PROBE ADAPTER

(71) Applicant: Haier US Appliance Solutions, Inc., Wilmington, DE (US)

(72) Inventors: Michael Robin Blackwood, Louisville, KY (US); James Lee Armstrong, Louisville, KY (US)

(21) Appl. No.: 17/704,160

(22) Filed: Mar. 25, 2022

(51) Int. Cl. A21B 3/13; G01K 13/00; G01K 1/14

(52) U.S. Cl. CPC A21B 3/135; G01K 13/00; G01K 1/14; G01K 2207/06; G01K 2207/08

(57) ABSTRACT

A bakeware assembly includes a cooking utensil defining a sidewall having a utensil aperture defined therethrough along an insertion direction. A probe adapter is mounted to the sidewall and includes an adapter wall defining an inner surface that is angled relative to the insertion direction to define a tapered channel positioned over the utensil aperture. A temperature probe includes a probe shaft sized for passing through the utensil aperture and a probe base positioned on the probe shaft and being configured for receipt within the tapered channel of the probe adapter, wherein the probe base engages the adapter wall when the temperature probe is in an installed position.

### FIELD OF THE INVENTION

The present subject matter relates generally to bakeware or cooking utensils, and more particularly to bakeware assemblies that include or are configured to receive temperature probes.

### BACKGROUND OF THE INVENTION

Certain conventional bakeware is designed for receiving a temperature probe for monitoring temperatures of the bakeware or food being cooked therein. For example, these temperature probes may be electrically coupled to a controller of a cooking appliance to facilitate a closed loop cooking cycle, e.g., stopping the cooking process when the food reaches a desired internal temperature.

However, conventional temperature probes are mounted to the cooking utensil or bakeware by using one or more mechanical clips that are bulky and are prone to falling off the bakeware. Alternatively, these temperature probes may pass through a wall of the bakeware but may commonly fail to form a proper seal with the bakeware, e.g., resulting in fluid leaks. In addition, these temperature probes tend to easily slide out of the bakeware when being placed in the oven or during a cooking process. Alternatively, the probe is sized to fit snugly within a hole in the bakeware, resulting in undesirably large forces to insert and remove the temperature probe.

Accordingly, an improved means of utilizing a temperature probe with bakeware would be desirable. More specifically, a bakeware assembly that includes a temperature probe that easy to install in a secure, leak-free manner, would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a bakeware assembly is provided including a cooking utensil defining a sidewall, wherein a utensil aperture is defined through the sidewall along an insertion direction, a probe adapter mounted to the sidewall, the probe adapter comprising an adapter wall that defines an inner surface that is angled relative to the insertion direction to define a tapered channel positioned over the utensil aperture, and a temperature probe. The temperature probe include a probe shaft sized for passing through the utensil aperture and a probe base positioned on the probe shaft and being configured for receipt within the tapered channel of the probe adapter, wherein the probe base engages the inner surface of the adapter wall when the temperature probe is in an installed position.

In another exemplary embodiment, a temperature probe assembly for use with a cooking utensil is provided. The cooking utensil includes a sidewall defining a utensil aperture through the sidewall along an insertion direction. The temperature probe assembly includes a probe adapter mounted to the sidewall, the probe adapter comprising an adapter wall defining an inner surface that is angled relative to the insertion direction to define a tapered channel positioned over the utensil aperture and a temperature probe comprising a probe shaft sized for passing through the utensil aperture and a probe base positioned on the probe shaft and forming an interference fit with the probe adapter when the temperature probe is in an installed position.

In yet another exemplary embodiment, a bakeware assembly is provided including a cooking utensil defining a sidewall, wherein a utensil aperture is defined through the sidewall along an insertion direction, a probe adapter mounted to the sidewall, the probe adapter comprising an adapter wall defining a channel positioned over the utensil aperture, and a temperature probe. The temperature probe includes a probe shaft sized for passing through the utensil aperture and a probe base positioned on the probe shaft and being configured for receipt within the channel of the probe adapter, wherein the probe base engages the adapter wall when the temperature probe is in an installed position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a bakeware assembly including a cooking utensil and a temperature probe according to an exemplary embodiment of the present subject matter.

FIG. 2 provides a perspective view of the exemplary cooking utensil of FIG. 1 according to exemplary embodiments of the present subject matter.

FIG. 3 provides a side, cross-sectional view of the exemplary bakeware assembly of FIG. 1 according to an exemplary embodiment of the present subject matter.

FIG. 4 provides a cross-sectional view of a probe adapter mounted to the exemplary cooking utensil of FIG. 1 according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained briefly above, conventional means for obtaining the temperature of food items being cooked within cooking utensils or bakeware have several drawbacks. For example, temperature probes are often attached to the cookware in a clumsy or nonsecure manner, may be difficult to insert and/or remove from the cookware, generate leaks within the bakeware, or are otherwise ineffective in obtaining accurate temperatures throughout a cooking process. Accordingly, aspects of the present subject matter are generally directed to a bakeware assembly that includes an adapter for holding a temperature probe which may be attached to a side of bakeware. The adapter's internal structure may have a tapered diameter. In addition, or alternatively the temperature probe may itself include a tapered engagement surface. The temperature probe may attach or connect with the interior of the adapter, thereby resulting in an interference fit that provides an improved seal. The tapered adapter geometry also allows for variation in the probe geometry.

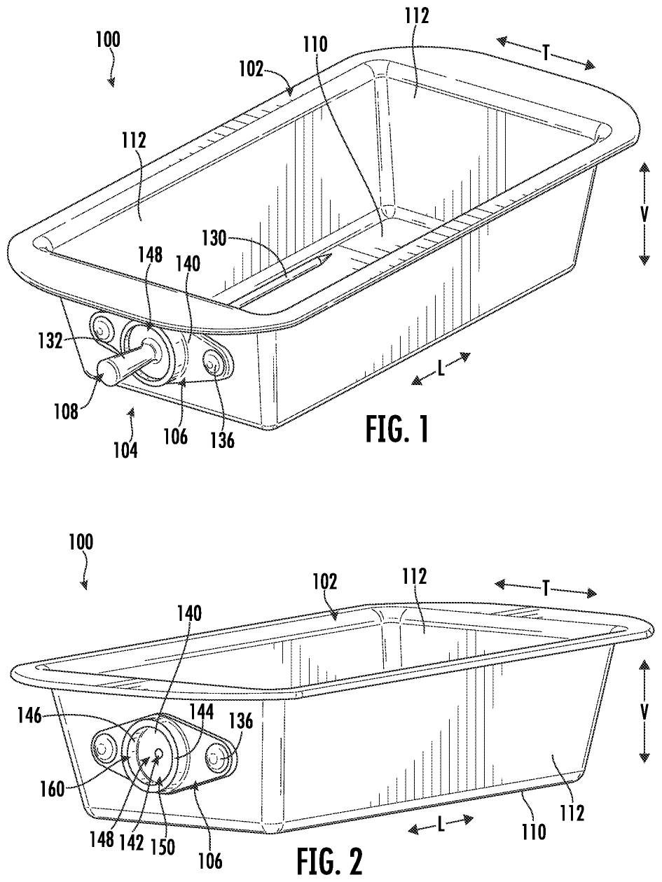

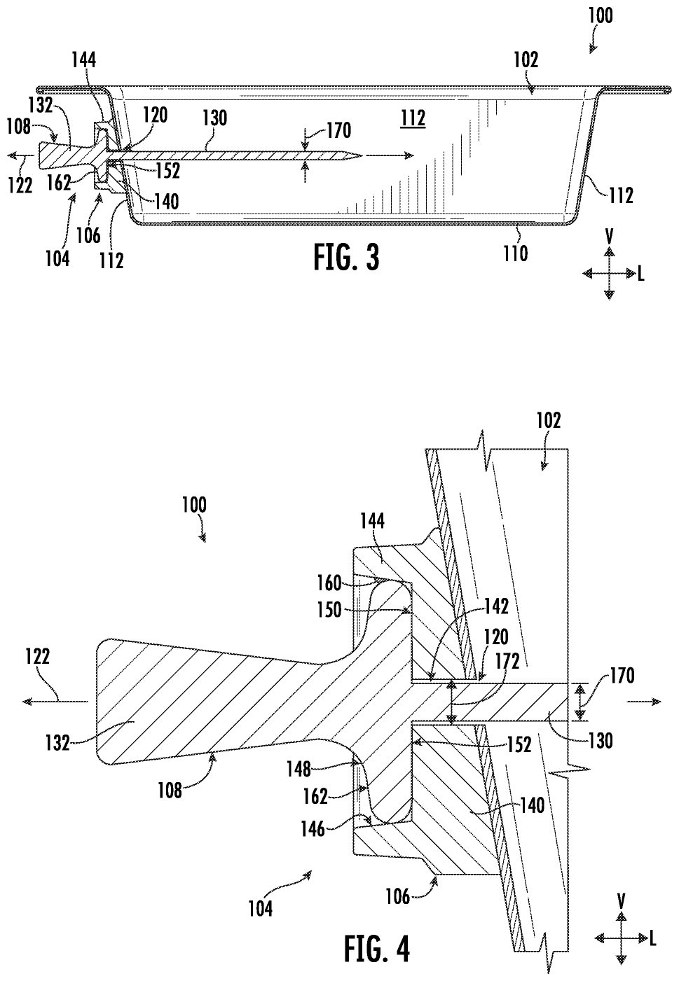

Referring now to the figures, an exemplary bakeware assembly 100 will be described according to exemplary embodiments of the present subject matter. Specifically, FIGS. 1 and 2 illustrate perspective views of bakeware assembly 100 while FIGS. 3 and 4 provide cross-sectional views of bakeware assembly 100. Although an exemplary embodiment of bakeware assembly 100 is described herein, it should be appreciated that bakeware assembly 100 is only one exemplary embodiment intended to facilitate discussion of aspects of the present subject matter. Variations and modifications to bakeware assembly 100 may be made while remaining within the scope of the present subject matter.

As illustrated, bakeware assembly 100 generally includes a cooking utensil 102 and a temperature probe assembly 104 mounted, attached, or formed thereon. As illustrated, temperature probe assembly 104 may generally include a temperature probe adapter 106 that is configured for receiving a temperature probe 108. Each of these components will be described in more detail below according to exemplary embodiments of the present subject matter. In general, temperature probe 108 may be in operative communication with a controller of a cooking appliance (e.g., via wired or wireless connection) for transmitting signals corresponding to the temperature of a food item being cooked within cooking utensil 102. In this manner, a closed-loop cooking process may be facilitated.

As best shown in FIG. 1, cooking utensil 102 generally defines a vertical direction V, a lateral direction L, and a transverse direction T, each of which is mutually perpendicular, such that an orthogonal coordinate system is generally defined. According to the illustrated embodiment, cooking utensil 102 has a generally rectangular footprint within a horizontal plane (e.g., a plane corresponding to lateral direction L and transverse direction T). Accordingly, cooking utensil 102 has a bottom wall 110 and four sidewalls 112 that generally extends upward along the vertical direction V from bottom wall 110. According to the illustrated embodiment, sidewalls 112 do not extend directly along the vertical direction V, but instead define an angle measured relative to the vertical direction V (e.g., between about 1° and 30°, between about 2° and 25°, between about 3° and 20°, between about 4° and 15°, or about 10°).

According to the illustrated embodiment, bakeware assembly 100 includes a rectangular cooking utensil 102 and temperature probe assembly 104 is mounted in a sidewall 112 of cooking utensil 102. However, it should be appreciated that according to alternative embodiments, cooking utensil 102 may include any other suitable shape, size, and/or geometry. Moreover, temperature probe assembly 104 may be configured for mounting on cooking utensil 102 in any other suitable manner.

According to the illustrated embodiment of the present subject matter, cooking utensil 102 may generally define a utensil aperture 120 that passes through sidewall 112 along an insertion direction 122. In this regard, according to the illustrated embodiment, the insertion direction 122 corresponds to the lateral direction L and is generally the direction along which temperature probe 108 slides into cooking utensil 102. As illustrated, probe adapter 106 may be secured to sidewall 112 over utensil aperture 120, e.g., to facilitate secure receipt of temperature probe 108, as described in more detail below.

As best illustrated in FIGS. 3 and 4, temperature probe 108 may generally include a probe shaft 130 that is sized for passing through utensil aperture 120 and a probe handle or probe base 132 that is positioned on probe shaft 130. In general, probe shaft 130 may generally include an embedded temperature sensor for measuring the temperature of food within cooking utensil 102. In this regard, probe shaft 130 may be generally constructed from a metal material and in any suitable temperature sensor may be positioned within are operably coupled to probe shaft 130. As used herein, “temperature sensor” or the equivalent is intended to refer to any suitable type of temperature measuring system or device positioned at any suitable location for measuring the desired temperature. Thus, for example, the temperature sensor may be any suitable type of temperature sensor, such as a thermistor, a thermocouple, a resistance temperature detector, a semiconductor-based integrated circuit temperature sensor, etc. In addition, the temperature sensor may be positioned at any suitable location and may output a signal, such as a voltage, to a controller that is proportional to and/or indicative of the temperature being measured.

In addition, according to the exemplary embodiment, probe base 132 may be attached to an end of probe shaft 130, e.g., to facilitate interaction with probe adapter 106 and to act as a handle for user manipulation. According to exemplary embodiments, probe base 132 may be formed from any suitable thermally insulating and high temperature resistance material, e.g., such as silicone. For example, according to the illustrated embodiment, probe base 132 may be overmolded on the probe shaft 130. In addition, probe base 132 may house a wireless communication module or may have a wired connection (not shown) for communicatively coupling temperature probe 108 to an external controller.

In general, probe adapter 106 may be mounted to or integrally formed with cooking utensil 102 and may be configured for receiving temperature probe 108, as described in more detail below. In this regard, for example, probe adapter 106 may be formed from the same or similar material as cooking utensil 102 (e.g., such as a metal, stainless steel, etc.). In addition, probe adapter 106 may be attached to sidewall 112 of cooking utensil using one or more mechanical fasteners 136 (e.g., such as rivets). According to still other embodiments, probe adapter 106 may be integrally formed or manufactured into cooking utensil 102. Other constructions are possible and within the scope of the present subject matter.

According to exemplary embodiments, probe adapter 106 includes an adapter seat 140 that is positioned against sidewall 112. As illustrated adapter seat 140 defines an adapter aperture 142 that is positioned over utensil aperture 120 of cooking utensil 102. In this regard, adapter aperture 142 and utensil aperture 120 may be co-linear such that probe shaft 130 slides through both adapter aperture 142 and utensil aperture 120 into cooking utensil 102.

According to exemplary embodiments, probe adapter 106 may further include an adapter wall 144 that extends away from adapter seat 140 along the insertion direction 122. As explained below, adapter wall 144 may define an inner surface 146 that may be angled relative to the insertion direction 122 to define a tapered channel 148 that is positioned over adapter aperture 142 and utensil aperture 120. According to the illustrated embodiment, probe base 132 and tapered channel 148 may both have circular footprints in a plane taken perpendicular to the insertion direction 122. As temperature probe 108 is inserted into an installed position, probe shaft 130 may slide freely through adapter aperture 142 and utensil aperture 120 while probe base 132 slides into tapered channel 148. Notably, as the diameter of tapered channel 148 decreases, probe base 132 engages inner surface 146 of adapter wall 144.

Notably, probe base 132 may have an interference fit with adapter wall 144 when temperature probe 108 is in the installed position. Accordingly, probe base 132 may generally form a fluid seal with probe adapter 106 in the installed position, thereby reducing the likelihood of leaks through utensil aperture 120. In addition, the engagement between probe base 132 and adapter wall 144 may facilitate secure attachment of temperature probe 108 to probe adapter, reducing the likelihood of inadvertent removal.

According to exemplary embodiments, probe adapter 106 defines a flat seating surface 150 that may be defined perpendicular to the insertion direction 122 for engaging probe base 132 when temperature probe 108 is in the installed position. Specifically, according to the illustrated embodiment, adapter seat 140 may have an angled or tapered profile such that adapter seat 140 can sit on an angled sidewall 112 while also providing flat seating surface for engaging a bottom side 152 of probe base 132 when temperature probe 108 is inserted along the insertion direction 122.

Notably, probe adapter 106 and/or temperature probe 108 may include additional features to ensure secure engagement of the temperature probe in the installed position. For example, probe adapter 106 may further define a protrusion, detent, or other retention structure for engaging probe base 132 in the installed position. For example, as illustrated, a detent 160 may protrude from inner surface 146 of adapter wall 144 into tapered channel 148, wherein detent 160 engages a top side 162 of probe base 132 when temperature probe 108 is in the installed position.

Notably, it may be desirable to facilitate easy insertion and/or removal of temperature probe 108 while also ensuring secure engagement in the installed position. In this regard, for example, a probe diameter 170 of probe shaft 130 may be less than an aperture diameter 172 of utensil aperture 120 and adapter aperture 142. For example, aperture diameter 172 of utensil aperture 120 and/or adapter aperture 142 may be approximately 1% larger, 3% large, 5% larger, 10% larger, or larger, than probe diameter 170.

It should be appreciated that variations and modifications may be made to the construction of bakeware assembly 100 without departing from the scope of the present subject matter. For example, the illustrated embodiment shows a tapered adapter wall 144 for securely engaging a substantially constant diameter probe base 132. However, according to alternative embodiments tapered channel 148 may instead be cylindrical, and the tapered engagement between probe adapter 106 and temperature probe 108 may be achieved by adjusting the geometry of probe base 132. Other variations or modifications are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A bakeware assembly comprising:
a cooking utensil defining a sidewall, wherein a utensil aperture is defined through the sidewall along an insertion direction;
a probe adapter mounted to the sidewall, the probe adapter comprising an adapter wall that defines an inner surface that is angled relative to the insertion direction to define a tapered channel positioned over the utensil aperture; and
a temperature probe comprising:
a probe shaft sized for passing through the utensil aperture; and
a probe base positioned on the probe shaft and being configured for receipt within the tapered channel of the probe adapter, wherein the probe base engages the inner surface of the adapter wall when the temperature probe is in an installed position.

2. The bakeware assembly of claim 1, wherein a probe diameter of the probe shaft is less than an aperture diameter of the utensil aperture.

3. The bakeware assembly of claim 1, wherein the probe base has an interference fit with the adapter wall when the temperature probe is in the installed position.

4. The bakeware assembly of claim 1, wherein the probe adapter defines a flat seating surface that is defined perpendicular to the insertion direction for engaging the probe base when the temperature probe is in the installed position.

5. The bakeware assembly of claim 1, wherein the probe adapter further defines a detent that protrudes from the inner surface of the adapter wall into the tapered channel, wherein the detent engages the probe base when the temperature probe is in the installed position.

6. The bakeware assembly of claim 1, wherein the probe base is constructed of silicone.

7. The bakeware assembly of claim 1, wherein the probe base is overmolded onto the probe shaft.

8. The bakeware assembly of claim 1, wherein the probe adapter is formed from metal.

9. The bakeware assembly of claim 1, wherein the probe adapter is attached to the sidewall of the cooking utensil with a mechanical fastener.

10. The bakeware assembly of claim 1, wherein the probe adapter is integrally formed with the cooking utensil.

11. The bakeware assembly of claim 1, wherein the cooking utensil has a rectangular footprint in a horizontal plane.

12. A temperature probe assembly for use with a cooking utensil, the cooking utensil comprising a sidewall defining a utensil aperture through the sidewall along an insertion direction, the temperature probe assembly comprising:
a probe adapter mounted to the sidewall, the probe adapter comprising an adapter wall defining an inner surface that is angled relative to the insertion direction to define a tapered channel positioned over the utensil aperture; and
a temperature probe comprising a probe shaft sized for passing through the utensil aperture and a probe base positioned on the probe shaft and forming an interference fit with the probe adapter when the temperature probe is in an installed position.

13. The temperature probe assembly of claim 12, wherein a probe diameter of the probe shaft is less than an aperture diameter of the utensil aperture.

14. The temperature probe assembly of claim 12, wherein the probe base has an interference fit with the adapter wall when the temperature probe is in the installed position.

15. The temperature probe assembly of claim 12, wherein the probe adapter defines a flat seating surface that is defined perpendicular to the insertion direction for engaging the probe base when the temperature probe is in the installed position.

16. The temperature probe assembly of claim 12, wherein the probe adapter further defines a detent that protrudes from the inner surface of the adapter wall into the tapered channel, wherein the detent engages the probe base when the temperature probe is in the installed position.

17. The temperature probe assembly of claim 12, wherein the probe base is constructed of silicone.

18. The temperature probe assembly of claim 12, wherein the probe base is overmolded onto the probe shaft.

19. The temperature probe assembly of claim 12, wherein the probe adapter is formed from metal and is attached to the sidewall of the cooking utensil with a mechanical fastener.

20. A bakeware assembly comprising:
a cooking utensil defining a sidewall, wherein a utensil aperture is defined through the sidewall along an insertion direction;
a probe adapter mounted to the sidewall, the probe adapter comprising an adapter wall defining a channel positioned over the utensil aperture; and
a temperature probe comprising:
a probe shaft sized for passing through the utensil aperture; and
a probe base positioned on the probe shaft and being configured for receipt within the channel of the probe adapter, wherein the probe base engages the adapter wall when the temperature probe is in an installed position.
